(19) United States
(12) Patent Application Publication
(10) Pub. No.: US 2008/0285417 A1
(43) Pub. Date: Nov. 20, 2008

(54) Optical Information Recording Medium and Method for Recording to the Same

(76) Inventors: Hideo Kusada, Osaka (JP); Noboru Yamada, Osaka (JP); Tomiharu Hosaka, Kyoto (JP)

Correspondence Address: WENDEROTH, LIND & PONACK L.L.P., 2033 K. STREET, NW, SUITE 800, WASHINGTON, DC, 20006, US

(21) Appl. No.: 11/630,519

(22) PCT Filed: Apr. 13, 2006
(86) PCT No.: PCT/JP2006/307815

§ 371 Date: Dec. 21, 2006

(30) Foreign Application Priority Data
Apr. 15, 2005 (JP) 2005-117966

(51) Int. Cl. G11B 3/74

(52) U.S. Cl. 369/94

(57) ABSTRACT

An optical information recording medium with favorable recording/reproducing characteristics and corrosion resistance is offered. To this end, the optical information recording medium of the present invention comprises in this sequence at least substrate 001 that has a guide groove, reflective layer 002, light-absorbing layer 003, reflected light side protective layer 004, recording layer 006 with optical properties that are transformed reversibly due to irradiation with laser light, incident light side protective layer 012 with a film thickness ≦50 nm, resin layer 010, and a transparent substrate 011 that is irradiated with laser light, where incident light side protective layer 012 includes a plurality of material layers, and among this plurality of material layers, a layer that constitutes an incident light side material layer 009 which is the most closest to the transparent substrate has minimum internal stress.

### TECHNICAL FIELD

The present invention relates to an optical information recording medium on which it is possible to record/reproduce or overwrite information at high density using an optical means of laser light irradiation or the like, and a method for recording to an optical information recording medium.

### BACKGROUND ART

Known media with which large quantities of information can be recorded and that can be overwritten and reproduced at high speed include magnetooptical recording media, phase change type recording media and the like. For these types of optical information recording media, differences in the optical properties of the recording materials that are produced by localized irradiation with laser light are utilized during recording/reproducing and rewriting. In the example of magnetooptical recording media, different rotational angles of the polarization plane of reflected light are utilized that are generated by different magnetization states. At the same time, for phase change type recording media that utilize the quantity of reflected light at certain wavelengths to differentiate between the crystalline state and the amorphous state, by modulating the output power of the laser, it is possible to erase recorded information at the same time that new information is overwritten. For this reason, it is advantageous to be able to rewrite an information signal at high speed.

The layer structure of conventional optical information recording medium 200 (referred to below as recording medium), as shown in FIG. 4, is an example of a phase change type recording medium that is widely used as a DVD-RAM with a capacity of 4.7 GB on one side.

Recording medium 200 comprises, in sequence above transparent substrate 101, incident light side protective layer 102, incident light side diffusion barrier layer 103, recording layer 104, reflected light side diffusion barrier layer 105, reflected light side protective layer 106, light absorption layer 107 and reflective layer 108. These layers are primarily formed by the sputtering method. Furthermore, above reflective layer 108 are resin layer 109, adhesive layer 110, and bonding base material 111.

When the material used for incident light side protective layer 102, for example a material with ZnS as a major component, has a refractive index of ≧2.0 with respect to the laser light wavelength, in order to satisfy the optical properties of recording medium 200 it is necessary for the film thickness of incident light side protective layer 102 to be thicker, to the extent of up to 130 nm. Consequently, the period of time for forming the film becomes longer, which is a problem with regard to the production cost becoming higher. At the same time, for example, in a material with SiO₂ as the main component, when using a material that has a refractive index of ≦2.0 with respect to the wavelength of the laser light, the film thickness of incident light side protective layer 102 can be thinner to the extent ≦50 nm and still satisfy the optical properties of recording medium 200. However, since the separation between recording layer 104 and transparent substrate 101 becomes narrower, when repeated recording is carried out, transparent substrate 101 can be damaged by heat from heated recording layer 104, and there is a problem with deterioration of quality in the recording signal.

In order to solve problems of this type, optical information recording media are proposed that utilize other materials, such as ZnS, Zr oxide, Cr oxide or the like as the main component of reflected light side protective layer 106, and moreover Al oxide, Si oxide, Mg oxide or fluoride or the like as the main component incident light side protective layer 102 (for example, see Patent Document 1).

However, in the abovementioned conventional optical information recording media, since the film thickness of the incident light side protective layer would be thinner, the corrosion resistance of the recording medium would deteriorate readily, and in addition, since the thermal conductivity of the material of the protective layer would be relatively high, high laser power would be necessary when recording.

Additionally, when this recording medium is recorded/reproduced with a relative linear speed between an optical head and a recording medium of 8-12 m/s, which is a normal rotational speed, the resin layer will readily suffer heat damage since the laser light irradiation time will be relatively long, and there will be a problem with deterioration of the recording signal quality.

Patent Document 1: Japanese published unexamined patent application No. 2005-4950

### INVENTION DISCLOSURE

In order to solve the abovementioned problems, an optical information recording medium of the present invention comprises in this sequence at least a substrate that has a guide groove, a reflective layer, a light-absorbing layer, a reflected light side protective layer, a recording layer with optical properties that are transformed reversibly due to irradiation with laser light, an incident light side protective layer with a film thickness of ≦50 nm, a resin layer, and a transparent substrate that is irradiated with laser light, where the incident light side protective layer includes a plurality of material layers, and among this plurality of material layers, a layer that constitutes an incident light side material layer which is the most closest to the transparent substrate possesses minimum internal stress.

It is possible by the present invention to obtain an optical information recording medium that possesses favorable corrosion resistance, possesses favorable recording/reproducing properties and is able to carry out recording with recording sensitivity that is suitable from a practical standpoint.

### BRIEF DESCRIPTION OF THE DRAWINGS

FIG. 1 is a drawing that shows the layer structure of an optical information recording medium that relates to the present invention.

FIG. 2 is a graph that shows the laser wavelength dependency of the refractive index for the material layers in an optical information recording medium that relates to the present invention.

FIG. 3 is a graph that shows the internal stress measurement results for the material layers in an optical information recording medium that relates to the present invention.

FIG. 4 is a drawing that shows the layer structure of a conventional optical information recording medium.

### NUMERICAL REFERENCES

001 Substrate
002, 108 Reflective layer
003, 107 Light-absorbing layer
004, 106 Reflected light side protective layer
005, 105 Reflected light side diffusion barrier layer
006, 104 Recording layer
007, 103 Incident light side diffusion barrier layer
008 First material layer
009 Second material layer
010, 109 Resin layer
011, 101 Transparent substrate
012, 102 Incident light side protective layer
110 Adhesive layer
111 Bonding base material
100, 200 Optical information recording medium

### DETAILED DESCRIPTION OF THE PREFERRED EMBODIMENT

Optical information recording media (referred to below as recording media) relating to the present invention are discussed in further detail below.

### Embodiment 1

A recording medium comprises at least a reflective layer, a light-absorbing layer, a reflected light side protective layer, a recording layer, an incident light side protective layer, a resin layer and a transparent substrate in the sequence above a substrate.

The substrate has a guide groove in order to guide the laser light. As the material, a resin such as PM A, or glass or the like can be used. In addition, the substrate is formed with alternating groove portions and land portions. Furthermore, substrates with different ratios for the widths of groove portion and the land portion can be used. Although there is no particular limitation on the film thickness for the substrate, a value ≧0.1 mm and ≦1.2 mm is preferred. If the film thickness is ≧0.1 mm, it becomes easier to suppress heat damage during formation of the thin film, and if the film thickness is ≦1.2 mm, the portability of the recording medium can be ensured.

The reflective layer is composed of a material that primarily contains Ag or Al. The phrase “primarily contains” here refers to constituting the largest proportion among the constituent elements in a material, and has the same meaning elsewhere in this document. In this case, a film thickness that is ≧80 nm and <300 nm is preferred. A film thickness that is ≧120 nm and <200 nm is further preferred. In materials with high thermal conductivity that have Ag or Al as the main component, as the film thickness increases, it is easier for the light-absorbing layer to cool rapidly during the laser irradiation, and the recrystallization of the amorphous mark that is recorded on the recording layer can be suppressed. Furthermore, if the film thickness in the present embodiment is employed, the decrease of the mass producibility due to lengthening the film formation time can be suppressed, and a reduction in quality in the recording mark can also be suppressed with maintaining a favorable recording sensitivity.

The light-absorbing layer is composed of a material that primarily contains Si. In this case, a film thickness that is ≧20 nm and <50 nm is preferred. Furthermore, a mixture material composed of Si and Cr for the light-absorbing layer is preferred from the optical perspective. This is because the ratio between the light absorptivity of the crystalline portion of the recording layer and the light absorptivity of the amorphous portion (absorptivity ratio) can be further increased, and thus, further improvement of the erasure characteristics of the recording medium is possible. In this case, a film thickness that is ≧25 mm and ≦40 mm is preferred. For this reason, the recording sensitivity is lowered and the recrystallization of the recorded amorphous mark in the recording layer can be carried out more readily, so that it is possible to suppress the decrease in quality of the recorded mark.

The reflected light side protective layer primarily contains a sulfide of Zn, and contains at least one chemical compound selected from the group that includes a nitride of Si and the oxides of Sn, Ta and Bi. In this case, a film thickness that is ≧25 nm and <45 nm is preferred. Furthermore, for the reflected light side protective layer, a mixture material composed of ZnS and SiO₂ is preferred. As a result, the thermal conductivity can be lower. In this case, a film thickness that is ≧30 nm and <40 nm is preferred. The deterioration of the recording sensitivity due to the distance between the recording layer and the light-absorbing layer becomes smaller is suppressed, and the difference between the crystalline state and the amorphous state of the recording medium in terms of the quantity of reflected light can become larger. Furthermore, the reflected light side protective layer can be constituted from a plurality of material layers, and in this case it is preferred for the layer composed of a mixture material of ZnS and SiO₂ to be the thickest film.

A recording layer that contains primarily Ge or Te, and furthermore contains at least one element selected from Sb, Bi and In, and a film thickness of ≧3 nm and <12 nm is preferred. As a result, the crystallization speed can be more rapid, and favorable recording/reproducing characteristics can be obtained when the linear speed of the recording medium is faster with respect to the laser light. Additionally, a film thickness that is ≧5 nm and <10 nm is further preferred. As a result, the difference between the crystalline state and the amorphous state of the recording medium in terms of the quantity of reflected light can become larger, and furthermore by suppressing fluctuations in the volume between the crystalline state and the amorphous state, it is possible to suppress the deterioration of the repeated recording characteristics.

The incident light side protective layer is a thin layer with a film thickness that is ≦50 nm, and plays a role in suppressing heat damage to the resin layer. In concrete terms, the incident light side protective layer of the present invention can includes a plurality of material layers, and among this plurality of material layers, the layer that constitutes the incident light side material layer that is closest to the transparent substrate (referred to below as material layer A) will possess minimal internal stress. In the conventional technology, the distance between the recording layer and the resin layer is ≦50 nm, and the resin layer readily sustains heat damage due to heat absorbed by the recording layer during recording, which readily leads to a deterioration in signal mark quality. The cause of this is considered to be such that the resin layer readily undergoes thermal contraction when heated and absorbs moisture, and this heat acts to cause hydrolytic cleavage of the resin layer to occur readily, and the heat acts to cause the resin layer and the incident light side protective layer to become detached readily at the interface. Thus, in the present embodiment, a material layer having a film thickness ≦50 nm with water barrier properties and low internal stress is provided between the recording layer and the resin layer, which prevents water from permeating from the exterior into the resin layer. This will result in being able to control heat damage to the resin layer. Although not specifically provided for in the present embodiment, a material layer with water barrier properties and low internal stress can also be provided between the transparent substrate and the resin layer. As a result of this, it would be possible to prevent the permeation of water from the exterior through the transparent substrate into the resin layer. This will result in being able to control heat damage to the resin layer.

Furthermore, the magnitude of the internal stress of the layer that constitutes material layer A is preferably ≧−300 N/mm² and ≦300 N/mm². Naturally, when the internal stress of each material layer that forms a portion of the recording layer is measured, a comparison of the results will show which among the material layers has the smallest value, and the material layer that possesses the minimum internal stress is preferred. However, since the internal stress of the material layer will be affected by other layers in the recording medium, such measurements will be difficult. Thus, for material layer A having minimum internal stress, a comparison will be made of the measured values obtained for each single layer material layer of a given material and with a given film thickness that is constructed above the substrate, and these results will be read as the internal stress of material layer A having minimum value. The method for calculating the internal stress of thin films is shown below.

Single layer films of various ZnS—SiO₂ compositions were formed above a substrate (material: BK7) with a thickness of approx. 0.2 mm. Furthermore, a profilometer was used to measure the amount of change in the flexibility of the substrate before and after forming the film, and the internal stress a can be determined according to the formula below.

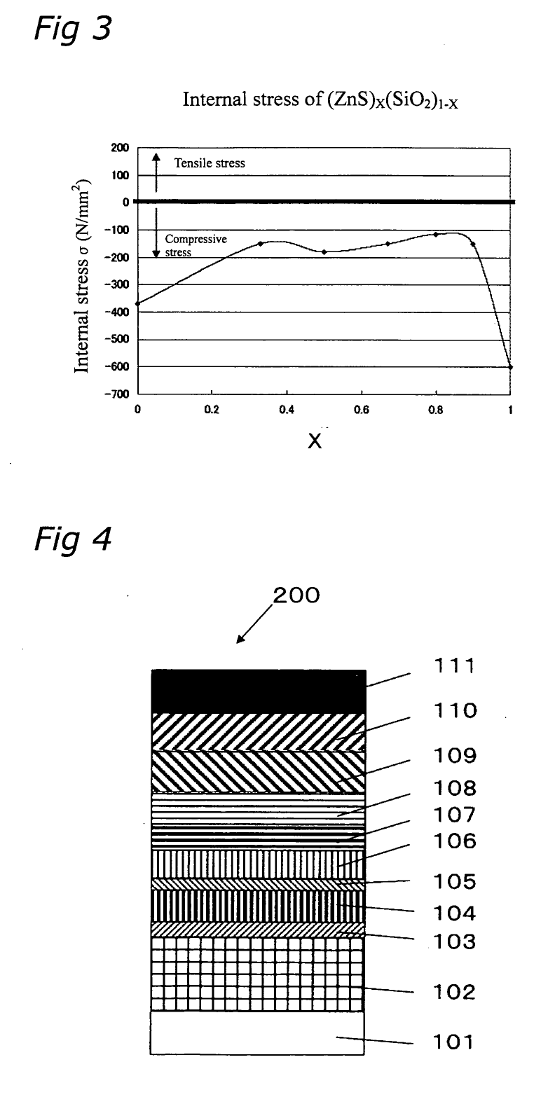

σ=(E×b²×4×δ)/(3×(1−ν)×d×l²)

where E is the Young's modulus for the substrate, ν is Poisson's ratio for the substrate, b is the thickness of the substrate, 1 is the length of the substrate, d is the thickness of the thin film and δ is the magnitude of the change in the flexibility. In the present embodiment, E is 79,200 N/mm², ν is 0.214, l is 10 mm, and b is 0.2 mm. The target thickness for the thin film as applied by the sputtering technique is 100 nm. In this case, in order to compare the internal stresses of each material layer, the parameters except for δ will have fixed values. For this reason, the internal stress is small in this case means that the magnitude of the change in flexibility is small. Based on the above, the results of the internal stress measurements are shown in FIG. 3 for the case of (ZnS)ₓ(SiO₂)₁₋ₓ. Here, it can be seen that when x≧0.3 and ≦0.9 nm, the internal stress of the thin film becomes smaller.

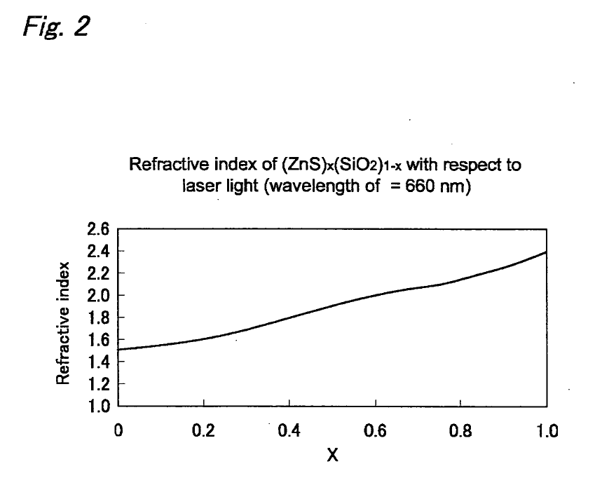

In addition, for at least one of the plurality of material layers, the refractive index is ≦1.90, and more preferably ≦1.60, with respect to an incident light wavelength of λ=660 nm. It is more preferable for the refractive index in material layer A, and further preferable for the refractive index of the entire incident light side protective layer to be within this range. With a lower refractive index, even if the film thickness for the entire incident light side protective layer is ≦50 nm, since there will be an enough distance between the recording layer and the resin layer, it will be more difficult for the resin layer to sustain heat damage, and it will be possible to suppress the deterioration in signal mark quality. Additionally, when the incident light side protective layer film has a fixed thickness, the lower the refractive index, the larger can be the difference in the quantity of reflected light between the crystalline phase and the amorphous phase of the recording medium. For example, at least one layer from the plurality of material layers can have SiO₂ as the main component of the material. FIG. 2 shows the refractive index of (ZnS)ₓ(SiO₂)₁₋ₓ with respect to laser light having a wavelength of λ=660 nm.

Moreover, it is preferable for at least one material layer that constitutes the incident light side protective layer to have an extinction coefficient ≦0.05. As a result, the absorption of light by the material layer is suppressed, and the recording layer can be irradiated with light more effectively.

For material layer A, in order to obtain a dense film with low internal stress and high water barrier properties, an inorganic material is preferred. In addition, it is desirable for the material to be transparent with respect to the incident light. In concrete terms, material layer A will contain primarily a sulfide of Zn, and furthermore will contain at least one chemical compound selected from a nitride of Si and the oxides of Si, Ta and Bi. Further preferred is a material that contains sulfides of Zn and oxides of Si, as represented by (ZnS)ₓ(SiO₂)₁₋ₓ (where 0.3≦x≦0.9). By using such materials, the incident light side protective layer can have a higher refractive index. In addition, by having a uniform particle shape in the thin film, it is possible to remove completely the causes of noise in the recording layer. By using a mixture material of ZnS and SiO₂, it is possible for the thermal conductivity to be reduced more than with the common oxide materials, and so the laser power for the recording layer can readily be lowered.

The film thickness of material layer A is preferably ≧2 nm and <20 nm, and furthermore is more preferably ≧5 nm and ≦15 nm. As a result, the deterioration of corrosion resistance is suppressed, and the difference in the quantity of reflected light between the crystalline state and the amorphous state of the recording medium can become larger.

At least one of the material layers other than material layer A can contain at least one chemical compound selected from the oxides of Si, Zn, Zr, Al and Mg, the nitrides of Zr, Al and B, and fluorides of Ce, La and Mg. Furthermore, materials that contain oxides of Si with the minimum extinction coefficient and refractive index are the most preferred.

The film thickness of the resin layer is preferably ≧1 μm and <30 μm. A film thickness of ≧5 μm and <25 μm is further preferred. Within this range, the resin can be applied uniformly during the formation of the resin layer. The material of the resin layer preferably has an acrylate ester compound as the main component with the addition of a chemical compound that possesses water-repellant properties. For example, with the solvents such as trimethylolpropane triacrylate, neopentyl glycol diacrylate, p-dimethylaminobenzoic acid ethyl ester, tricyclodecane-3,8-dimethylol diacrylate, trimethylolpropane tripropoxy triacrylate, dioxane glycol diacrylate, neopentyl glycol diacrylate, tetrahydrofurfuryl acrylate and the like, chemical compounds which possess water-repellant properties including alkyltrialkoxysilane, tetraalkoxysilane and fluoroalkyltrimethoxysilane, and/or fluorinated surfactants are preferably employed. As examples of fluorinated surfactants, Megafac F-142D, F-144D, F-150, F-171, F-177, F-183, and Defensa TR-220K from Dainippon Ink and Chemicals, Inc., are preferred.

The thickness of the transparent substrate is preferably ≧570 μm and ≦600 μm. In more concrete terms, in order for the distance from the substrate surface of the incident light side to the recording layer to be the same as the distance of 600±30 μm in the conventional DVD-RAM configuration, it is preferable to have a thickness of ≧575 μm and ≦595 μm.

In the present invention, with respect to the substrate onto which each layer is laminated, it is necessary to have good transcription of the guide groove during the formation on the substrate, and with respect to the transparent substrate, the birefringence requires to be uniform on the substrate surface. The amount of reflected light from the incident light is known to undergo significant change depending on the birefringence of the substrate on the incident light side, and in order to obtain a uniform amount of reflected light on the surface of the recording medium, it was necessary to control to the extent possible the birefringence distribution of the transparent substrate. In the configuration of the present invention, without taking account of the substrate groove transcription in the transparent substrate, it is possible to optimize the substrate formation conditions based solely on the uniformity of the birefringence. The birefringence of the transparent substrate is preferably 0±30 nm over the entire substrate surface.

Furthermore, a layer that has water barrier properties can first be formed above the transparent substrate. In this way, the transparent substrate and the substrate with each of the layers laminated onto it can readily be bonded together. This layer can be composed of the same material as material layer A, and formed by using the sputtering technique or vapor deposition methods such as PVD, CVD and the like.

In addition to providing material layer A that is a water barrier properties with low internal stress, it is effective to use a resin layer with increased heat resistance as a technique of controlling the heat damage to the resin layer. A resin material that possesses water resistance and water barrier properties can be applied for this purpose. Moreover, a resin with increased adhesiveness for the incident light side protective layer can be used in the configuration of the present invention, and in this case can reduce the interface delamination between the resin layer and the incident light side protective layer.

### Embodiment 2

Next, an example will be mentioned of a method for the recording/reproducing and erasure of a signal on the recording medium of Embodiment 1 above.

The recording/reproducing and erasure of a signal employs a recording/reproducing device that is provided at least with an optical head that includes a semiconductor laser light source and an objective lens, a driving device for guiding the position of irradiation by the laser light, a tracking and focusing control device for controlling the track direction and the position along the vertical direction on the film surface, a laser driving device for modulating the laser power, and a rotation controlling device for rotating the recording medium.

For a signal to be recorded or erased, the rotation controlling device is used to rotate the recording medium, and the laser light is narrowed down to a microscopic spot for carrying out the irradiation. The EFM modulation method is used as the signal system. By modulating a power level of the laser light between a power level for producing an amorphous state which can reversibly transform into the amorphous state, and a power level for producing a crystalline state which can reversibly transform into the crystalline state, a recording mark or erased portion is formed in a portion of the recording layer, and the recording, erasure or overwriting of information is carried out. Here, the portion for the irradiation of a power level for producing an amorphous state is formed by a pulse sequence, which is referred to as a multipulse. Furthermore, the portion can be formed by a pulse that is not a multipulse.

When recording a signal to the recording medium of Embodiment 1, the laser wavelength, the light pick-up numerical aperture, the laser output, the linear speed of the recording medium with respect to the laser light and the like are adjusted appropriately, heating of the layer composition of the recording medium by the laser irradiation during recording can be suppressed, and recording can take place under conditions where no discoloration or deformation of the resin layer takes place and no delamination of the resin layer from the incident light side protective layer will be produced. As a result, it is possible to obtain favorable recording/reproducing characteristics. In more concrete terms, it becomes more difficult for the quantity of heat produced by the heating of the recording layer to be transmitted to the resin layer, and recording conditions are established that do not cause heat damage to the resin layer. The quality of the reproduced signal deteriorates when the resin layer sustains heat damage, but the cause of this is considered to be that the resin layer undergoes deformation/discoloration and delamination from the incident light side protective layer due to the heat damage, and the reflected light from the irradiating laser will fluctuate. When the resin layer deteriorates, this deterioration appears more pronounced when the recording is repeated hundreds of times. In other words, when recording is carried out in a particular track only several times, there will be no damage to the quality of the reproduced signal since the deterioration of the resin layer is minor, but when recording is carried out in this same track several hundred times, there is progressive deterioration of the resin layer and the quality of the reproduced signal will continue gradually to worsen.

The quantity of heat produced in the recording layer during laser irradiation becomes larger depending on the area of the light spot, the light irradiation energy, and the duration of the laser light irradiation, and as a result can more readily cause heat damage to the resin layer. In order to avoid this, the laser wavelength and the light pick-up numerical aperture are set and the size of the light spot is adjusted, the laser output is set and the energy of the light irradiation of the recording layer is adjusted, the linear speed of the recording medium with respect to the laser light is set and adjustments of the duration of the laser light irradiation and the like are carried out.

It is important not to cause any heat damage to the resin layer depending on the quantity of heat produced in the recording layer due to the laser light irradiation, a laser light wavelength of ≧600 mm and ≦700 nm is preferred. As a result, the usual increase in the laser light spot size that is proportional to the wavelength is suppressed, and it is possible to carry out recording at high density. Additionally, changes in the refractive index related to the wavelength in the material layers that constitute the recording medium are suppressed, and a medium can readily be designed for which the recording medium contrast is sufficiently satisfactory. Furthermore, a laser light wavelength that is ≧640 nm and ≦680 nm is more preferred.

The light pick-up numerical aperture is preferably ≧0.55 and ≦0.70. As a result, it is possible to carry out recording at high density, and it is possible to avoid causing heat damage to the resin layer when the laser spot is focused too narrowly.

The linear speed for the recording medium with respect to the laser light is preferably ≧18 m/s and ≦80 m/s. Furthermore, linear speeds of ≧22 m/s are more preferred. As a result, heat damage to the resin layer caused by the cumulative heat is prevented, and in addition it is possible to prevent difficulties in the laser tracking when the eccentricity of the recording medium becomes larger as the oscillations of the motor increase.

From the above, it can be made more difficult for the resin layer to sustain heat damage, and it is possible to obtain favorable recording/reproducing characteristics.

Furthermore, when the linear speed of the recording medium with respect to the laser light is fast, higher laser power is necessary during recording. However, in the configuration of the present invention that has a multilayer incident light side protective layer, the internal stress is lower and the water barrier properties are higher in the incident light side material layer (material layer A) that is closest to the transparent substrate, and the anti-corrosive properties and recording sensitivity can be increased by using a material with low thermal conductivity. Moreover, when using low refractive index materials in other layers, the difference in the quantity of reflected light between the crystalline state and the amorphous state of the recording medium can become larger. For this reason, since the film thickness of the reflected light side protective layer can be thicker, it becomes possible to have a more desirable recording sensitivity. Consequently, even when the recording medium is being rotated at a high speed ≧22 m/s, recording can be carried out at a suitably practicable laser power. Additionally, even at linear speeds faster than 65 m/s, recording can be carried out with suitable recording sensitivity in a practical manner.

Furthermore, recording, reproducing and erasure of an information signal can be carried out on both the groove portion and the land portion of the guide groove, and there is no question that carrying out what is referred to as land-groove recording is associated with increasing the capacity. At this point, it is necessary to devise a depth and shape for the guide groove and a reflectance configuration for the recording medium so that cross-talk and cross-erase will not occur. Furthermore, a total width along the vertical direction to the groove direction for the groove portion and the land portion of 1.40 μm is preferred. Recording is possible with a groove pitch of ≧1.40 μm, but the effect of reducing the heat damage of the resin layer of the present invention appears more pronounced when high density recording is carried out using a groove of ≦1.40 μm.

Next, various types of recording medium 100 based on the above embodiments are manufactured and the results of carrying out evaluations are stated using Examples.

### Example 1

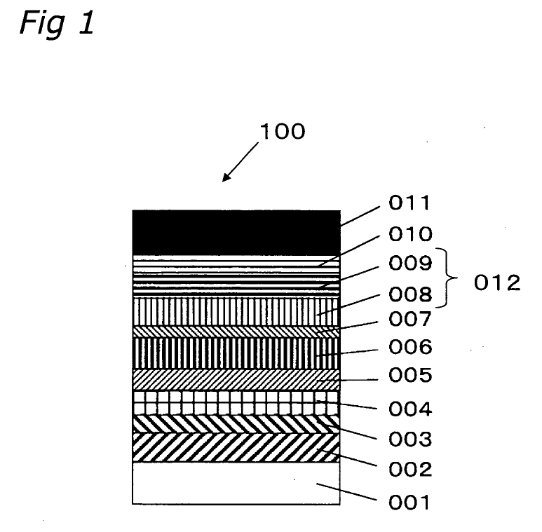

The main structure and method of manufacturing for recording medium 100 of the present Example are explained using FIG. 1.

Recording medium 100 comprises above substrate 001 in sequence reflective layer 102, light-absorbing layer 003, reflected light side protective layer 004, reflected light side diffusion barrier layer 005, recording layer 006, incident light side diffusion barrier layer 007, incident light side protective layer 012 (first material layer 008 and second material layer 009), resin layer 010, and transparent substrate 011.

Substrate 001 had a thickness of 0.6 mm and used a disk-shaped polycarbonate resin substrate with a diameter of 120 mm.

Reflective layer 002 was formed as a 160 nm film using an Ag₉₈Pd₁Cu₁ (atom %) alloy target.

Light-absorbing layer 003 was formed as a 30 mm film using an Si₆₆Cr₃₄ (atom %) alloy target.

Reflected light side protective layer 004 used a mixture of 20 mol % of SiO₂ in ZnS as the target, and when the recording layer is in the amorphous state the reflectance Rc is ≧15%, and the film thickness was equal to the signal amplitude of the groove and land. The film thickness in this example was 32 nm.

The abovementioned reflective layer 002, light-absorbing layer 003 and reflected light side protective layer 004 were formed by the sputtering method using the respective targets in a vacuum film formation chamber with an Ar gas flow.

Reflected light side diffusion barrier layer 005 was formed with a film thickness of 2 nm using a Ge₈₀Cr₂₀ (atom %) alloy target in a vacuum film formation chamber with an argon/nitrogen mixture gas flow composed of 20% partial pressure of nitrogen in argon.

Recording layer 006 was formed with a film thickness of 8 nm using a Ge₃₈Sb₃Bi₅Te₅₄ (atom %) target in a vacuum film formation chamber with an Ar gas flow.

Incident light side diffusion barrier layer 007 was formed with a film thickness of 2 nm using a Ge₈₀Cr₂₀ (atom %) alloy target in a vacuum film formation chamber with an argon/nitrogen mixture gas flow composed of 20% partial pressure of nitrogen in argon.

Incident light side protective layer 012 is constituted from first material layer 008 on the recording layer 006 side, and second material layer 009 on the transparent substrate 011 (described later) side.

First material layer 008 was formed with a film thickness of 5 nm by RF sputtering using an SiO₂ target in a vacuum film formation chamber with an Ar gas flow. At this time, a single layer of first material layer 008 was formed on a separate glass chip in order to examine the refractive index, and the refractive index was 1.48 at a wavelength of 660 nm. Furthermore, BN, CeF₃, LaF₃, MgF₂, MgO, and MgSiO₃ can also be used as the material for first material layer 008.

Second material layer 009 was formed with a film thickness of 5 nm by RF sputtering using a mixture target of (ZnS)₈₀(SiO₂)₂₀ (mol %) target in a vacuum film formation chamber with an Ar gas flow. At this time, a single layer of second material layer 009 was formed on a separate glass chip in order to examine the refractive index again, and the refractive index was 2.10 at a wavelength of 660 nm, with the normal refractive index being in the range of 1.8˜2.4. Furthermore, ZnO, Ga₂O₃, SnO2, Bi₂O₃ can also be used as the material for second material layer 009.

Resin layer 010 is formed with a film thickness of 20 μm by the spin coat method using a UV-curable acrylate-type resin (SD-715, Dainippon Ink and Chemicals, Inc., 56 parts) and a fluorochemical surface-modifying agent (TR-220K, Dainippon Ink and Chemicals, Inc., 10 parts) mixed in a solvent.

Following this, after transparent substrate 011 with a thickness of 0.58 mm was placed on and bonded, the resin was cured by ultraviolet radiation and the recording medium was formed.

The conditions for the formation of transparent substrate 011 were optimized on the basis of the uniformity of the birefringence, and the results of examining the birefringence at a wavelength of 660 nm gave a value of 0±15 nm over the entire surface of the recording medium. Furthermore, for transparent substrate 1 formed by optimizing the formation conditions in order to increase the transcribability of the groove during the formation of recording medium, the birefringence was 0±50 nm over the entire surface of the recording medium.

Additionally, a water barrier layer formed beforehand is placed on the bonding surface of transparent substrate 011. This layer is formed with a film thickness of 10 nm by the RF sputtering method using a (ZnS)₈₀(SiO₂)₂₀ (mol %) mixture as the target.

The sputtering method is not limited to RF sputtering, and for example sputtering with the pulse DC method in an atmosphere that is a mixture of Ar gas and oxygen gas using conductive targets with oxygen defects can be used.

### Example 2

The thickness of first material layer 008 was 2 nm, otherwise recording medium 100 was formed in the same manner as in Embodiment 1.

### Example 3

The thickness of first material layer 008 was 10 nm, otherwise the recording medium was formed in the same manner as in Embodiment 1.

### Example 4

The thickness of second material layer 009 was 3 nm, otherwise the recording medium was formed in the same manner as in Embodiment 1.

### Example 5

The thickness of second material layer 009 was 10 nm, in addition the thickness of reflected light side protective layer 004 was 30 nm, otherwise the recording medium was formed in the same manner as in Embodiment 1.

### Example 6

Second material layer 009 was formed using a (ZnS)₇₀(SiO₂)₃₀ target, otherwise the recording medium was formed in the same manner as in Embodiment 1.

### Comparative Example 1

First material layer 008 was formed using the same (ZnS)₈₀(SiO₂)₂₀ target as was used for second material layer 009, and the thickness of the layers were both 2 nm. Moreover, the thickness of reflected light side protective layer 004 was 24 nm, otherwise the recording medium was formed in the same manner as in Embodiment 1.

### Comparative Example 2

Second material layer 009 was formed using the same SiO₂ target as was used for first material layer 008, and the thickness of the layers were both 10 nm. Moreover, the thickness of reflected light side protective layer 004 was 36 nm, otherwise the recording medium was formed in the same manner as in Embodiment 1.

The evaluation methods used for recording media 100 of this type are found below.

A power level for producing an amorphous state that a portion of recording layer 006 can reversibly transform into the amorphous state by irradiating with laser light is referred to as P1, and a power level for producing a crystalline state the portion can reversibly transform into the crystalline state by irradiating with laser light is referred to as P2. By modulating between laser power P1 and P2, a recording mark or an erased portion are formed, and the recording, erasure and overwriting of information were carried out in this manner. The EFM modulation method was used as the signal system, the bit length was 0.28 μm, and the disk rotational speed was adjusted appropriately. The track pitch was 1.20 μm, more specifically a substrate was used in which the groove portions and land portions are alternatively formed every 0.60 μm width.

Substrates with different ratios for the widths of the groove portion and land portion can also be used. In the land track, the value of the peak P1 of the ratio of the reproduce output to the noise (C/N ratio) were determined. In this case with the light pick-up and the linear speed of recording medium 100 at 24 m/s, the cases where the P1 value was <22 mW are indicated with a 0, and where it was ≧22 mW are indicated with a Δ. Additionally, when the linear speed was 64 m/s, the cases where the P1 value was <33 mW are indicated with a 0, and where it was ≧33 mW are indicated with a Δ.

In addition, when the linear speed was 24 m/s, the cycling characteristics were evaluated and the heat damage to the resin layer was evaluated. Taking the cycle frequency as the frequency of deterioration with a C/N ratio of −3 dB after ten overwrite cycles, the cases where the cycle frequency was ≧10,000 cycles are indicated with a ◯, and where it was <10,000 cycles are indicated with a Δ.

For the corrosion resistance of the disk, it was determined whether corrosion was present after the disk had been placed in an 80% environment at 90° C. for 100 h. The cases where no corrosion was observed are indicated with a ◯, the cases where recording medium 100 was used without problems but where some corrosion was observed are indicated with a Δ; and the cases where the use of recording medium 100 was hindered and corrosion was observed are indicated with an x.

Moreover, when various recording media 100 were irradiated with a laser having a wavelength of 660 nm, the reflectance Rc was measured from a portion of the disk mirror when recording layer 006 was in the amorphous state, and the reflectance Ra was measured from a portion of the disk mirror when recording layer 006 was in the crystalline state. Furthermore, appropriate adjustments were made so that Rc would be ≧15.0%.

The results of the evaluation experiments are shown in Table 1.

TABLE 1

| | |
|---|---|
| First material layer 008 of the | Second material layer 009 of the |
| incident light side protective layer | incident light side protective layer |

| | | | | film | | | film |
|---|---|---|---|---|---|---|---|
| | | | refractive | thickness | | refractive | thickness |
| Examples | | material | index | (nm) | material | index | (nm) |
| Example | 1 | SiO₂ | 1.48 | 5 | (ZnS)₈₀(SiO₂)₂₀ | 2.10 | 5 |
| | 2 | SiO₂ | 1.48 | 2 | (ZnS)₈₀(SiO₂)₂₀ | 2.10 | 5 |
| | 3 | SiO₂ | 1.48 | 10 | (ZnS)₈₀(SiO₂)₂₀ | 2.10 | 5 |
| | 4 | SiO₂ | 1.48 | 5 | (ZnS)₈₀(SiO₂)₂₀ | 2.10 | 3 |
| | 5 | SiO₂ | 1.48 | 5 | (ZnS)₈₀(SiO₂)₂₀ | 2.10 | 10 |
| | 6 | SiO₂ | 1.48 | 5 | (ZnS)₇₀(SiO₂)₃₀ | 2.00 | 5 |
| Comparative | 1 | (ZnS)₈₀(SiO₂)₂₀ | 2.1 | 2 | (ZnS)₈₀(SiO₂)₂₀ | 2.1 | 2 |
| Example | 2 | SiO₂ | 1.48 | 10 | SiO₂ | 1.48 | 10 |

| | | | | | | linear | |
|---|---|---|---|---|---|---|---|
| | thickness of | | | | | speed: | |
| | the reflected | | | linear speed: 24 m/s | | 64 m/s | |
| | light side | | | recording | cycle | recording | |
| | protective | Rc | Ra | sensitivity | fre- | sensitivity | corro- |
| Examples | layer (nm) | (%) | (%) | P1 (mW) | quency | P1 (mW) | sion |

| | | | | | | | | |
|---|---|---|---|---|---|---|---|---|
| Example | 1 | 32 | 16.5 | 3.2 | ∘ | ∘ | ∘ | ∘ |
| | 2 | 32 | 16 | 3 | ∘ | ∘ | ∘ | ∘ |
| | 3 | 32 | 16.8 | 3.5 | ∘ | ∘ | ∘ | ∘ |
| | 4 | 32 | 16.4 | 3 | ∘ | ∘ | ∘ | ∘ |
| | 5 | 30 | 15.2 | 3.8 | ∘ | ∘ | ∘ | ∘ |
| | 6 | 32 | 16.5 | 3.2 | ∘ | ∘ | ∘ | ∘ |
| Comparative | 1 | 24 | 15.5 | 4.2 | Δ | ∘ | Δ | ∘ |
| Example | 2 | 36 | 16 | 3.4 | — | — | — | x |

According to the above results, in the recording medium 100 of Examples 1 through 6 of the present invention, the recording sensitivity together with cycling frequency were all favorable, and no corrosion was observed. Accordingly, it can be seen that the optical information recording medium obtained has favorable recording and reproducing properties and corrosion resistance.

At the same time, the results obtained in Comparative Example 1 for recording sensitivity were not as favorable as for the Examples. In Comparative Example 2, there were problems with corrosion.

### Other Embodiments

The Embodiments above do not exhaustively disclose the examples of the present invention, and do not limit the present invention in any way. Except for where they would be contrary to the object of the present invention, many variations are possible.

For example, an incident light side protective layer that is composed from three or more material layers would be applicable to the present invention.

### INDUSTRIAL APPLICABILITY

The optical information recording medium and method for manufacturing the medium of the present invention are applicable to various types of recording media.

1-20. (canceled)

21. An optical information recording medium comprising in this sequence at least a substrate that has a guide groove, a reflective layer, a light-absorbing layer, a reflected light side protective layer, a recording layer with optical properties that are transformed reversibly due to irradiation with laser light, an incident light side protective layer with a film thickness of ≦50 nm, a resin layer, and a transparent substrate that is irradiated with laser light,
wherein the incident light side protective layer includes a plurality of material layers, and
among the plurality of material layers, a layer that constitutes an incident light side material layer which is the most closest to the transparent substrate has minimum internal stress.

22. The optical information recording medium according to claim 21,
wherein at least one of the plurality of material layers has a refractive index of ≦1.90.

23. The optical information recording medium according to claim 21,
wherein at least one of the plurality of material layers has an extinction coefficient of ≦0.05.

24. The optical information recording medium according to claim 21,
wherein the incident light side material layer primarily contains sulfides of Zn, and furthermore contains at least one chemical compound selected from oxides of Sn, Ta and Bi, and nitrides of Si.

25. The optical information recording medium according to claim 21,
wherein the incident light side material layer contains sulfides of Zn and oxides of Si, as represented by (ZnS)ₓ(SiO₂)₁₋ₓ (where 0.3≦x≦0.9).

26. The optical information recording medium according to claim 21,
wherein the film thickness of the incident light side material layer is ≧2 m and <20 nm.

27. The optical information recording medium according to claim 21,
wherein at least one of the plurality of material layers other than the incident light side material layer contains at least one chemical compound selected from oxides of Si, Zn, Zr, Al and Mg, nitrides of Zr, Al and B, and fluorides of Ce, La and Mg.

28. The optical information recording medium according to claim 21,
wherein the reflected light side protective layer primarily contains a sulfide of Zn, and furthermore contains at least one chemical compound selected from oxides of Sn, Ta and Bi, and a nitride of Si.

29. The optical information recording medium according to claim 21,
wherein the film thickness of the reflected light side protective layer is ≧25 nm and <45 nm.

30. The optical information recording medium according to claim 21,
wherein the reflective layer primarily contains Ag or Al.

31. The optical information recording medium according to claim 21,
wherein the film thickness of the reflective layer is ≧80 nm and <300 nm.

32. The optical information recording medium according to claim 21,
wherein the light-absorbing layer primarily contains Si.

33. The optical information recording medium according to claim 21,
wherein the film thickness of the light-absorbing layer is ≧20 μm and <50 nm.

34. The optical information recording medium according to claim 21,
wherein the recording layer primarily contains Ge or Te, and furthermore contains at least one element selected from Sb, Bi and In.

35. The optical information recording medium according to claim 21,
wherein the film thickness of the recording layer is ≧3 nm and <12 nm.

36. The optical information recording medium according to claim 21,
wherein the birefringence of the transparent substrate with respect to the wavelength of the laser light is 0 nm±30 nm over the entire surface of transparent substrate.

37. The optical information recording medium according to claim 21,
wherein the thickness of the transparent substrate is ≧570 μm and <600 μm.

38. The optical information recording medium according to claim 21,
wherein the film thickness of the resin layer is ≧1 μm and <30 μm.

39. A method for recording onto an optical information recording medium according to claim 21,
wherein the laser light is incident from the transparent substrate side, and
the linear speed during recording onto the optical information recording medium with respect to the laser light is 18 m/s.

40. The method for recording onto an optical information recording medium according to claim 39,
wherein the wavelength of the laser light during recording is ≧600 nm and ≦700 nm, and
the numerical aperture of the lens for irradiating the laser light is ≧0.55 and ≦0.70.
